(19) United States
(12) Patent Application Publication
(10) Pub. No.: US 2003/0043342 A1
(43) Pub. Date: Mar. 6, 2003

(54) Multifocal corneal contact lenses

(76) Inventor: Leonard Seidner, Hawley, PA (US)

Correspondence Address: COLEMAN SUDOL SAPONE, P.C., 714 COLORADO AVENUE, BRIDGE PORT, CT, 06605-1601, US

(21) Appl. No.: 09/751,128

(22) Filed: Dec. 28, 2000

Related U.S. Application Data
(60) Provisional application No. 60/176,787, filed on Jan. 18, 2000.

(51) Int. Cl. G02C 7/04

(52) U.S. Cl. 351/161; 351/160 R

(57) ABSTRACT

In a pair of multifocal contact lenses for a patient, each lens has a concave posterior surface and a convex anterior surface. The anterior surface is formed with a power curve including a circular intermediate vision correction zone, an annular near vision correction zone contiguous with the circular central zone, and an annular distant vision correction zone contiguous with the near vision correction zone. The near vision correction zone and the distant vision correction zone are concentric or coaxial with the circular central correction zone.

### CROSS-REFERENCE TO A RELATED APPLICATION

This application relies for priority purposes on U.S. provisional application No. 60/176,787 filed Jan. 18, 2000.

### BACKGROUND OF THE INVENTION

This invention relates to a multifocal contact lens. More particularly, this invention relates to paired multifocal contact lenses.

Bifocal contact lenses are designed to correct or compensate for a condition of advancing age known as “presbyopia.” In a presbyopic eye, the ability to focus at near distances, such as the normal reading distance, and in some cases at intermediate distances, is diminished. The loss of focusing capability is due to hardening of the eye's natural crystalline lens material.

Generally, multifocal contact lenses (usually either bifocal, trifocal or aspheric) are concentric or segmented in configuration. In a conventional bifocal contact lens of the concentric type, a first, centrally located, circular correction zone constitutes either distant or near vision correction, while a second annular correction zone surrounding the first zone provides the corresponding near or distant vision correction, respectively. In a conventional bifocal contact lens of the segmented or translating type, the lens is divided into two somewhat D-shaped zones. Usually the upper area is for distant vision correction, whereas the lower area is for near vision correction. Such conventional segmented contact lenses require some sort of movement of the lens relative to the eye to achieve acceptable visual acuity for both distant and near vision.

It has been discovered that as a presbyopic patient ages, there is generally little change in the prescription for the patient's distance vision (in healthy eyes). However, the near vision prescription requires continual correction. At some point in monovision corrective lenses, when the near vision prescription strength is increased beyond a certain level, it appears that the distance vision of the patient suffers.

### OBJECTS OF THE INVENTION

An object of the present invention is to provide a pair of multifocal contact lenses.

Another object of the present is to provide such contact lenses which facilitate vision for emerging and advanced presbyopes.

A further, more particular, object of the present is to provide such contact lenses which do not decrease distance vision where the patient has a substantial correction for near vision.

These and other objects of the present invention may be gleaned from the drawings and detailed descriptions set forth herein.

### SUMMARY OF THE INVENTION

Each member of a pair of multifocal contact lenses in accordance with the present invention has a concave posterior surface and a convex anterior surface. The anterior surface of each lens is formed with a power curve including a circular central intermediate vision correction zone and an annular near vision correction zone contiguous with the intermediate vision correction zone. In addition, the power curve for each lens includes an outer annular distant vision correction zone contiguous with the near vision correction zone. The two annular zones or concentric or coaxial with the central, intermediate vision correction zone.

In order to optimize the coexistence of the patient's near vision and distance vision and to reduce the difficulty the advanced presbyope has in maintaining adequate distance vision, the various vision correction zones of the pair of lenses should be limited as to the differences in their corrective powers. In particular, the intermediate vision correction zone of each lens and the adjacent near vision correction zone should have optical powers differing in magnitude by less than approximately 1.5 diopters. Similarly, the intermediate vision correction zone and the distant vision correction zone of each lens should have optical powers differing in magnitude by less than approximately 1.5 diopters. Thus, neither eye receives image information with multiple focal corrections which differ by more than a predetermined limit.

Preferably, the intermediate vision correction zones each have a diameter of approximately 1.5 to approximately 3 mm, the near vision correction zones each have a diameter of approximately 2 to approximately 5 mm, and the annular distant vision correction zones each have a diameter of approximately 2.5 to approximately 8 mm, while the two lenses each have a diameter of approximately 13 to 15 mm.

The present invention may be used with all standard contact lens materials, i.e., rigid (gas permeable or PMMA), but is preferably used with soft (hydrogel) polymeric materials i.e., polymeric materials which contain at least about 10% by weight water after hydration, such as disclosed in U.S. Pat. Nos. 5,314,960 and 5,314,961.

### BRIEF DESCRIPTION OF THE DRAWING

FIG. 1 is a front elevational view showing the anterior surface of a corneal contact lens of a matched pair of bifocal type lenses.

FIG. 2 is a transverse cross-sectional view taken along line II-II in FIG. 1.

### DESCRIPTION OF THE PREFERRED EMBODIMENTS

The drawings illustrate a multifocal corneal contact lens for the dominant or the nondominant eye of a patient. Both lenses of a pair have the same configuration of correction zones.

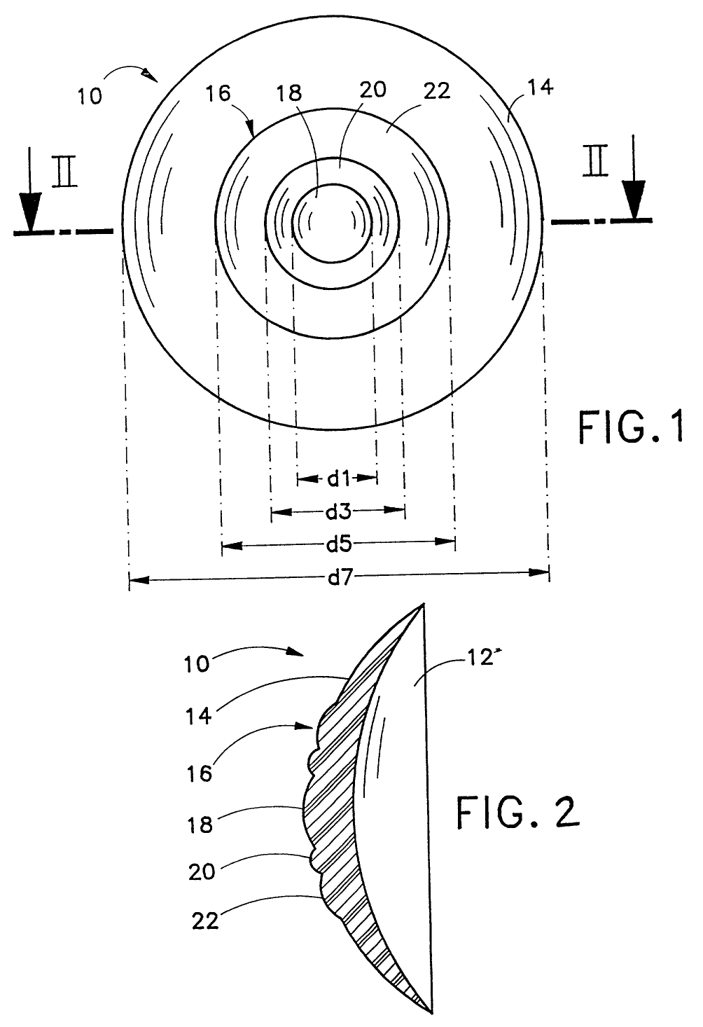

As shown in FIGS. 1 and 2, a corneal contact lens 10, has a concave posterior surface 12 and a convex anterior surface 14. Anterior surface 14 is formed with a power curve 16 including a circular intermediate vision correction zone 18 in the center of the lens and an annular near vision correction zone 20 contiguous with the intermediate distance correction zone. Annular correction zone 20 is concentric or coaxial with intermediate vision correction zone 18. Power curve 16 additionally includes an annular distant vision correction zone 22 contiguous with and surrounding near vision correction zone 20. Annular vision correction zone 22 is similarly concentric or coaxial with intermediate vision correction zone 18 and near vision correction zone 20.

Both lenses of a matched pair have the same intermediate-near-distant arrangement of correction zones 18, 20 and 22.

Generally, the intermediate vision provided by zones 18 covers distances from about two feet to approximately twelve feet from the viewer. Of course, there is substantial variation in the boundaries of this intermediate vision range from person to person. As a broad rule, intermediate vision is used for most activities inside the office, factory or home. Fine precision work and reading are accomplished take place within the near vision range, while activities such as driving require the use of distance vision.

Thus, for most activities of occupational and home life, a patient fitted with a pair of lenses 10 will have stereoscopic or binocular vision because of the use of the central intermediate zones 18 of the fitted pair of contact lenses and because the refractive powers of the central zones are approximately the same.

Intermediate vision correction zone 18 and near vision correction zone 20 of the same lens have optical powers differing by a maximum magnitude of approximately 1.5 diopters. Similarly, intermediate vision correction zone 18 and distant vision correction zone 22 of the same lens have optical powers differing by a maximum magnitude of approximately 1.5 diopters. In this way, each eye receives multiply focused image information, wherein the corrections are limited.

Generally, intermediate vision correction zones 18 of a matched pair lenses 10 (i.e., for the same patient) will have approximately the same corrective power. Accordingly, the near vision correction zone 20 of one contact lens and the intermediate correction zone 18 of the other contact lens will have optical powers differing in magnitude by less than approximately 1.5 diopters. This result is believed to be particularly beneficial in that the difference in focal correction of the image information from the two eyes will be circumscribed, thereby facilitating fusing or combining of the image information in the occipital (optical) cortex.

It is contemplated that some difference in the optical powers of the intermediate zones 18 of the two lenses is permissible. However this difference should be no greater than approximately 1.5 diopters.

Intermediate vision correction zone 18 of either lens of a matched pair has a diameter d1 in a range between approximately 1.5 and approximately 3 mm. Annular near vision correction zone 20 has a diameter d3 of approximately 2 to approximately 5 mm. Annular distant vision correction zone 22 has a diameter d5 ranging between approximately 2.5 and approximately 8 mm. Each lens 10 itself has a diameter d7 between approximately 13 and 15 mm.

The different optical correction zones of lens 10 may be spheric or aspheric. Lens 10 may be made of any standard contact lens material, i.e., rigid (gas permeable or PMMA), but is preferably made of soft (hydrogel) polymeric material, i.e., polymeric materials which contain at least about 10% by weight water after hydration, such as disclosed in U.S. Pat. Nos. 5,314,960 and 5,314,961.

For most presbyopic individuals, a pair of multifocal contact lenses 10 and 24 as described herein provides optimal vision correction for most activities of daily life. During work and in home situations, intermediate vision correction zones 18 are used together most commonly. In near vision or distance vision, the patient uses image information obtained through the near vision correction zone 20 or the distant vision correction zone 22, respectively.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are offered by way of example to facilitate comprehension of the invention and should not be construed to limit the scope thereof.

What is claimed is:

1. A pair of multifocal contact lenses for a patient, each lens having a concave posterior surface and a convex anterior surface, one of said posterior surface and said anterior surface being formed with a power curve including a circular central intermediate vision correction zone, an annular near vision correction zone contiguous with said circular central intermediate vision correction zone, and an annular distant vision correction zone contiguous with said annular near vision correction zone, said near vision correction zone and said distant vision correction zone being concentric or coaxial with said circular central intermediate vision correction zone.

2. The pair of multifocal contact lenses defined in claim 1 wherein said power curve is formed on said anterior surface.

3. The pair of multifocal contact lenses defined in claim 2 wherein the intermediate vision correction zone of each lens and the adjacent near vision correction zone have optical powers differing in magnitude by less than approximately 1.5 diopters.

4. The pair of multifocal contact lenses defined in claim 3 wherein the intermediate vision correction zone and the distant vision correction zone of each lens have optical powers differing in magnitude by less than approximately 1.5 diopters.

5. The pair of multifocal contact lenses defined in claim 4 wherein the intermediate vision correction zone of each lens has a diameter of approximately 1.5 to approximately 3 mm, the near vision correction zone of each leans has a diameter of approximately 2 to approximately 5 mm, and the annular distant vision correction zone of each lens has a diameter of approximately 2.5 to approximately 8 mm, each of the two lenses having a diameter of approximately 13 to 15 mm.

6. The pair of multifocal contact lenses defined in claim 5 wherein the lenses are made of soft, hydrogel polymeric materials containing at least about 10% by weight water after hydration.

7. The pair of multifocal contact lenses defined in claim 1 wherein the intermediate vision correction zone of each lens and the adjacent near vision correction zone have optical powers differing in magnitude by less than approximately 1.5 diopters.

8. The pair of multifocal contact lenses defined in claim 1 wherein the intermediate vision correction zone and the distant vision correction zone of each lens have optical powers differing in magnitude by less than approximately 1.5 diopters.

9. The pair of multifocal contact lenses defined in claim 1 wherein the intermediate vision correction zone of each lens has a diameter of approximately 1.5 to approximately 3 mm, the near vision correction zone of each leans has a diameter of approximately 2 to approximately 5 mm, and the annular distant vision correction zone of each lens has a diameter of approximately 2.5 to approximately 8 mm, each of the two lenses having a diameter of approximately 13 to 15 mm.

10. The pair of multifocal contact lenses defined in claim 1 wherein the lenses are made of soft, hydrogel polymeric materials containing at least about 10% by weight water after hydration.

11. The pair of multifocal contact lenses defined in claim 1 wherein, in order to optimize the coexistence of the patient's near vision and distance vision and to reduce the difficulty the advanced presbyope has in maintaining adequate distance vision, the various vision correction zones of the pair of lenses are limited as to the differences in their corrective powers.

12. A pair of multifocal contact lenses for a patient, each lens having a concave posterior surface and a convex anterior surface, said anterior surface being formed with a power curve including a circular central intermediate vision correction zone, an annular near vision correction zone contiguous with said circular central intermediate vision correction zone, and an annular distant vision correction zone contiguous with said annular near vision correction zone, said near vision correction zone and said distant vision correction zone being concentric or coaxial with said circular central intermediate vision correction zone, adjacent vision correction zones of the pair of lenses being limited as to differences in corrective power.

13. The pair of multifocal contact lenses defined in claim 12 wherein the intermediate vision correction zone of each lens and the adjacent near vision correction zone have optical powers differing in magnitude by less than approximately 1.5 diopters and wherein the intermediate vision correction zone and the distant vision correction zone of each lens have optical powers differing in magnitude by less than approximately 1.5 diopters.

14. The pair of multifocal contact lenses defined in claim 12 wherein the intermediate vision correction zone of each lens has a diameter of approximately 1.5 to approximately 3 mm, the near vision correction zone of each leans has a diameter of approximately 2 to approximately 5 mm, and the annular distant vision correction zone of each lens has a diameter of approximately 2.5 to approximately 8 mm, each of the two lenses having a diameter of approximately 13 to 15 mm.
